(19) United States
(12) Patent Application Publication
(10) Pub. No.: US 2025/0336098 A1
(43) Pub. Date: Oct. 30, 2025

(54) METHOD, APPARATUS, AND MEDIUM FOR POINT CLOUD CODING

(71) Applicants: Douyin Vision Co., Ltd., Beijing (CN); Bytedance Inc., Los Angeles, CA (US)

(72) Inventors: Wenyi WANG, Beijing (CN); Yingzhan XU, Beijing (CN); Kai ZHANG, Los Angeles, CA (US); Li ZHANG, Los Angeles, CA (US)

(21) Appl. No.: 19/264,630

(22) Filed: Jul. 9, 2025

Related U.S. Application Data
(63) Continuation of application No. PCT/CN2024/071406, filed on Jan. 9, 2024.

(30) Foreign Application Priority Data
Jan. 9, 2023 (WO) PCT/CN2023/071216

(51) Int. Cl. G06T 9/00; G01S 17/89

(52) U.S. Cl. CPC G06T 9/001; G01S 17/89

(57) ABSTRACT

Embodiments of the present disclosure provide a method for point cloud coding. In the method, for a conversion between a current coding unit of a point cloud sequence and a bitstream of the point cloud sequence, a capturing laser capturing a point in the current coding unit is determined. At least one coordinate of the point in at least one direction is determined based on the capturing laser. The conversion is performed based on the at least one updated coordinate of the point.

### CROSS REFERENCE TO RELATED APPLICATIONS

This application is a continuation of International Application No. PCT/CN2024/071406, filed on Jan. 9, 2024, which claims the benefit of International Application No. PCT/CN2023/071216 filed on Jan. 9, 2023. The entire contents of these applications are hereby incorporated by reference in their entireties.

### FIELDS

Embodiments of the present disclosure relates generally to point cloud coding techniques, and more particularly, to point cloud geometry coordinate revision.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: determining, for a conversion between a current coding unit of a point cloud sequence and a bitstream of the point cloud sequence, a capturing laser capturing a point in the current coding unit; updating at least one coordinate of the point in at least one direction based on the capturing laser; and performing the conversion based on the at least one updated coordinate of the point. The method in accordance with the first aspect of the present disclosure revises the coordinate of the point based on the capturing laser of the point. In this way, the effectiveness and efficiency for point cloud geometry coding can be improved.

In a second aspect, an apparatus for point cloud coding is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a point cloud sequence which is generated by a method performed by a point cloud processing apparatus. The method comprises: determining a capturing laser capturing a point in a current coding unit of the point cloud sequence; updating at least one coordinate of the point in at least one direction based on the capturing laser; and generating the bitstream based on the at least one updated coordinate of the point.

In a fifth aspect, a method for storing a bitstream of a point cloud sequence is proposed. The method comprises: determining a capturing laser capturing a point in a current coding unit of the point cloud sequence; updating at least one coordinate of the point in at least one direction based on the capturing laser; generating the bitstream based on the at least one updated coordinate of the point; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder in accordance with some embodiments of the present disclosure;

FIG. 3 illustrates a block diagram that illustrates an example point cloud decoder in accordance with some embodiments of the present disclosure;

FIG. 4 illustrates a flowchart of the improved point cloud geometry coding using LIDAR characteristics in accordance with embodiments of the present disclosure;

FIG. 5 illustrates another flowchart of the improved point cloud geometry coding using LIDAR characteristics in accordance with embodiments of the present disclosure;

FIG. 6 illustrates a flowchart of a method for point cloud coding in accordance with embodiments of the present disclosure; and

FIG. 7 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

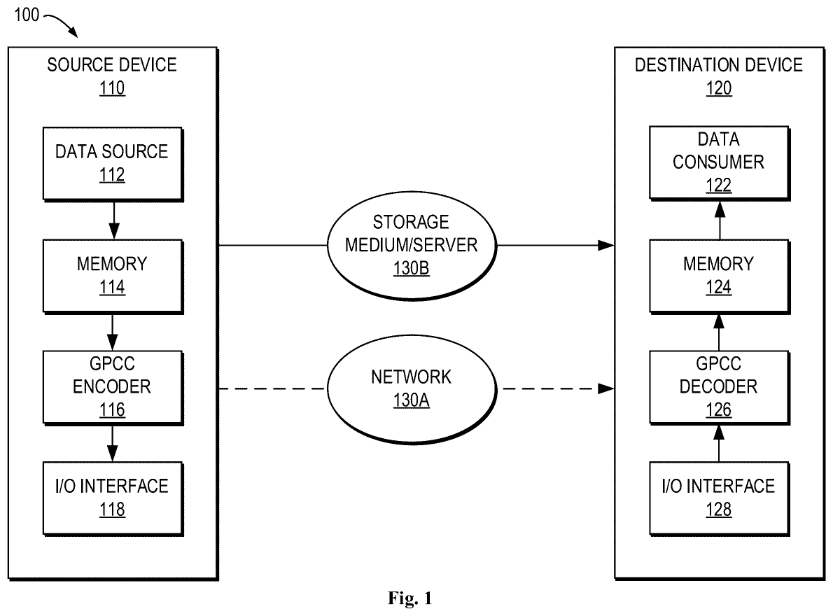

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

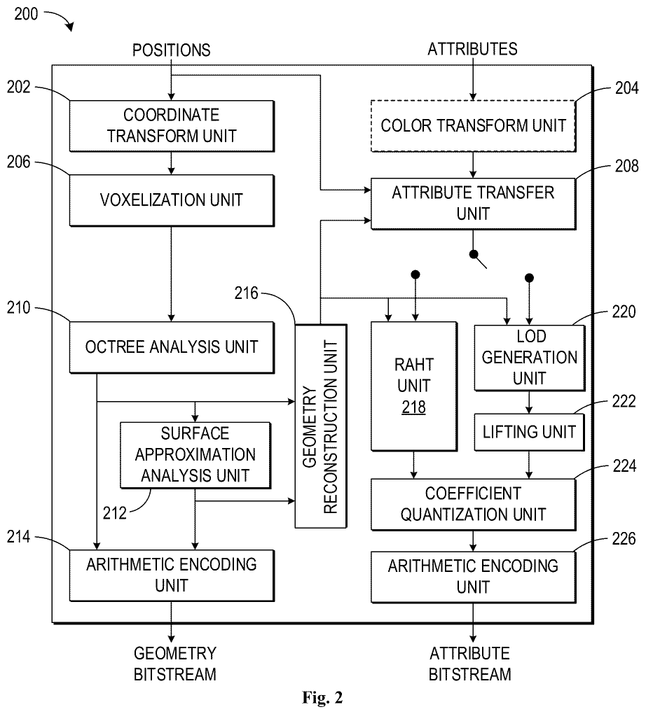

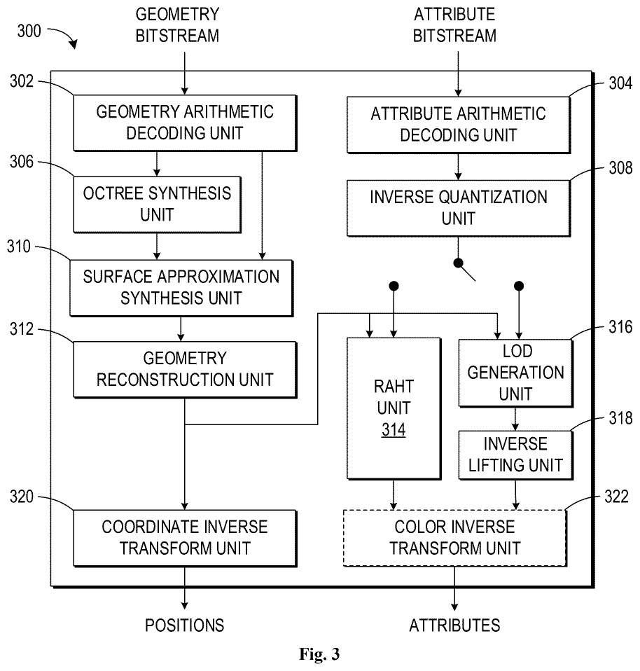

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively, or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Brief Summary

This disclosure is related to point cloud coding technologies. Specifically, it is related to point cloud geometry coordinates revision using LIDAR characteristics. The ideas may be applied individually or in various combination, to any point cloud coding standard or non-standard point cloud codec, e.g., the being-developed Geometry based Point Cloud Compression (G-PCC).

2.

Abbreviations

| | |
|---|---|
| G-PCC | Geometry based Point Cloud Compression |
| MPEG | Moving Picture Experts Group |
| 3DG | 3D Graphics Coding Group |
| CFP | Call For Proposal |
| V-PCC | Video-based Point Cloud Compression |
| DCM | Direct Coding Mode |
| IDCM | Inferred Direct Coding Mode |

### 3. Introduction

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on. One of the important applications of point cloud is automatic drive. In automatic drive, point cloud data mainly is captured by LIDAR. So some important characteristics of LIDAR can be leveraged to compress point cloud. For example, for standard spindle-type LIDAR, they always consists of multiple laser diodes aligned vertically, resulting an effective vertical (elevation) field of view. Then the entire unit can spin alone with its vertical axis at fixed speed to provide a full 360 degree azimuthal field of view. The elevation angle and azimuthal angle of laser beam can be leveraged to compress point cloud geometry information.

Point cloud codec can process the various information in different ways. Usually there are many optional tools in the codec to support the coding and decoding of geometry information and attribute information respectively. Among geometry coding tools in G-PCC, the following tools have an important influence for point cloud geometry coding performance.

### 3.1 Octree Geometry Compression

In G-PCC, one of important point cloud geometry coding tools is octree geometry compression, which leverages point cloud geometry spatial correlation. If geometry coding tools is enabled, a cubical axis-aligned bounding box, associated with octree root node, will be determined according to point cloud geometry information. Then the bounding box will be subdivided into 8 sub-cubes, which are associated with 8 child node of root node (a cube is equivalent to node hereafter). An 8-bit code is then generated by specific order to indicate whether the 8 sub-nodes contain points separately, where one bit is associated with one node. The 8-bit code is named occupancy code and will be signaled according to the occupancy information of neighbor node. Only the nodes which contain points will be subdivided into 8 sub-nodes furtherly. The process will be performed recursively until the node size is 1. So, the point cloud geometry information is converted into occupancy code sequences. In decoder side, occupancy code sequences will be decoded and the point cloud geometry information can be reconstructed according to the occupancy code sequences.

### 3.2 Planar Mode

Planar mode is a tool to improve occupancy code of octree node more efficiently. Before coding occupancy code of a node, the node will be judged whether it is eligible for planar mode or not according to specific eligibility condition in three dimensions separately.

Take the z axis as am example. If it is eligible for planar mode in z axis, a binary flag zIsPlanar is coded to signal whether its occupied child nodes belong to a same horizontal plane or not. If zIsPlaner is true, then an extra bit zPlanePosition is signaled if this plane is the lower plane or the upper plane, and the empty plane occupancy code can be ignored. Otherwise the node will continue normal tree coding process. The eligibility is based on tracking the probability of past coded node being planar as follows.
A node is eligible if and only if pₚₗₐₙₐᵣ≥T and d_{local}>3, where T is a user-defined probability threshold and d_{local} is local density which can derived according to neighbor node information.
Updating the probability pₚₗₐₙₐᵣ when a node occupancy is (de) coded or/and a node planar information is (de) coded as follows

$${p}_{p l a n a r} = ( L \times {p}_{p l a n a r} + δ ) / ( L + 1 )$$

where L=255 and 8 is 1 if the coded node is planar and 0 otherwise.

The flag zIsPlaner is coded by using a binary arithmetic coder with the 3 contexts based on the axis information. If zIsPlaner is true, the zPlanePosition is coded by using a binary arithmetic coder.

### 3.3 Inferred Direct Coding Mode (IDCM)

The octree representation, or more generally any tree representation, is efficient at representing points with a spatial correlation because trees tend to factorize the higher order bits of the point coordinates. For an octree, each level of depth refines the coordinates of points within a sub-node by one bit for each component at a cost of eight bits per refinement. Further compression is obtained by entropy coding the split information associated with each tree node.

However, if one node of octree contains isolated point, directly coding their relative coordinates in the node is better than octree representation. Because there are no other points in the node, no spatial correlation can be used. Directly coding point coordinates in a node/sub-node is called Direct Coding Mode (DCM). On the other hand, time complexity will be reduced using DCM because the octree recursive split process cannot be performed. In G-PCC, every node will be judged whether it is eligible for DCM or not according to specific eligibility condition, which is called Inferred Direct Coding Mode (IDCM). If a node is eligible for DCM, a binary flag is coded to signal if the DCM is applied (flag=1) or not (flag=0) to the node. If the flag is equal to 1, then points belonging to the associated volume are directly coded using the DCM. Otherwise (the flag is equal to 0), the tree coding process continues for the current node.

Currently, there are two eligibility conditions for IDCM.
parent-based-eligibility. There is only one occupied child (=the current node) at parent-node level, AND the grand-parent node has at most two occupied children (=the parent node+possibly one other node).
6N eligibility. There is only one occupied child (=the current node) at parent-node level, AND there is no occupied neighbour N (among the six neighbours sharing a face with the current cube associated with the current node).

### 3.4 Angular Mode

In G-PCC, angular mode is introduced to improve the compression of isolated point relative coordinate in IDCM and plane position in planar. It just can be used to real time LIDAR capturing point cloud data. For standard spindle-type LIDAR, each laser has a fixed elevation angle and captures fixed max number points per spin. The angular mode uses the prior fixed elevation angle of each laser. It uses the child node elevation distance from laser elevation angle to improve compression of binary occupancy coding through the prediction of the plane position of the planar mode and the prediction of z-coordinate bits in DCM nodes.

The angular mode is applied for nodes which is fulfilled with elevation eligibility, i.e., if the elevation size is lower than the smallest the elevation delta between two adjacent lasers. If the node is eligible, it is only passed by one laser in elevation direction. Then laser passing the node elevation angle will be found and several key points elevation angle of the node will be calculated. According to the relation of the several key points elevation angle and laser passing the node elevation angle, contexts will be determined to help code the z-coordinate bits in DCM and the plane position of z axis in planar mode.

### 3.5 Azimuthal Mode

Similar with angular mode, azimuthal mode is introduced to improve the compression of isolated point relative coordinate in IDCM and plane position in planar. It just can be used to real time LIDAR capturing point cloud data, too. The azimuthal mode uses the prior information that each laser captures fixed max number points per spin. It uses azimuthal angle of already coded nodes to improve compression of binary occupancy coding through the prediction of the x or y plane position of the planar mode and the prediction of x or y-coordinate bits in DCM nodes.

In current G-PCC, if a node is eligible for angular mode, it is eligible for azimuthal mode. If the node is eligible for azimuthal mode, the index of laser passing the node will be found. A prediction azimuthal angle will be determined according to the laser information and the azimuthal angle of an already coded node which has the same laser as the current node. Then several key points azimuthal angles of the node will be calculated. According to the position relation of the several key points azimuthal angles and prediction azimuthal angle, contexts will be determined to help code x-coordinate or y-coordinate bits in DCM and code the plane position of x or y axis in planar mode.

### 3.6 Geometry Quantization

Geometry quantization is one of important tools compressing geometry information. It will significantly improve geometry compression efficiency, but bring geometry distortion in terms of coordinates, such as coordinates precision of x, y and z.

### 4. Problems

The existing designs for point cloud geometry coding have the following problems:
1. In current G-PCC, geometry quantization significantly improves geometry compression efficiency, but brings distortion of x, y and z coordinates. At the same time, for LIDAR capturing point cloud data, there are some prior information which can be used to reduce the distortion of geometry coordinates. Specifically, the elevation information can be used to reduce the distortion of z coordinate, the azimuthal information can be used to reduce the distortion of x and y coordinates. For example, the capturing laser's elevation angle of a decoded point can be used to revise its z coordinate. For another example, the capturing laser beam's azimuthal angle of a decoded point can be used to revise its x and y coordinates.

### 5. Detailed Solutions

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.
1) It is proposed to determine the capturing laser of point.
   a. In one example, the capturing laser of the point may be the laser which captured this point when collecting the point cloud data.
   b. In one example, the coordinates of the point may have been quantized.
   c. In one example, the capturing laser of one point may be determined by searching the elevation angles of all lasers and comparing them with the elevation angle of the point.
      i. In one example, the capturing laser of one point may be the capturing laser with the smallest difference on elevation angle to the point.
      ii. In one example, the elevation angle may be represented by the angle value.
         1. In one example, the elevation angle of the point may be computed according to its coordinates.
         a. In one example, the elevation angle θ of the point (x, y, z) may be computed as follows,

$$θ = arctan ( \frac{z}{\sqrt{{x}^{2} + {y}^{2}}} )$$

where the arctan ( ) is the arc-tangent function.
iii. In one example, the elevation angle may be represented by the tangent value of the angle.
   1. In one example, the elevation angle of the point may be replaced with its tangent value, in this case, tangent value θ_{T} of the point (x, y, z) may be computed as follows,

$${θ}_{T} = \frac{z}{\sqrt{{x}^{2} + {y}^{2}}}$$

2. In one example, elevation angles of lasers may be replaced with the corresponding tangent values.
d. In one example, the capturing laser of one point may be determined by searching the corresponding values of all lasers and comparing them with the corresponding value of the point.
   i. In one example, the capturing laser of one point may be the capturing laser with the smallest difference on corresponding value to the point.
   ii. In one example, the corresponding value may be positively related to elevation angle.
   iii. In one example, the corresponding value may be tangent value of elevation angle.
   iv. In one example, the corresponding value may be z coordinate.
   v. In one example, the corresponding value may be computed according to its coordinates.
e. In one example, the capturing laser may be determined by inheriting from previous point.
f. In one example, the determining may be derived at the encoder.
g. In one example, the determining may be derived at the decoder.
2) It is proposed to revise the z coordinate of one point according to the elevation angle of its capturing laser.
   a. In one example, a base z coordinate of the point will be obtained according to the elevation angle of its capturing laser.
      i. In one example, the base z coordinate z_{b} of the point (x, y, z) will be obtained as follows,

$${z}_{b} = f ( x , y , θ )$$

where θ is the elevation angle of the capturing laser, f ( ) is a function that can map the point to the elevation angle of its capturing laser in z direction.
1. In one example, the function may be

$$f ( x , y , θ ) = tan ( θ ) \sqrt{{x}^{2} + {y}^{2}}$$

2. In one example, the function may be

$$f ( x , y , θ ) = θ \sqrt{{x}^{2} + {y}^{2}}$$

b. In one example, the laser head position shift in z direction may be added when computing the base z coordinate.
   i. In one example, the base z coordinate z_{b} of the point (x, y, z) will be obtained as follows,

$${z}_{b} = f ( x , y , θ ) + {z}_{s}$$

where θ is the elevation angle of the capturing laser, f ( ) is a function that can map the point to the elevation angle of its capturing laser in z direction, the zₛ is the the laser head position shift in z direction.
1. In one example, the function may be

$$f ( x , y , θ ) = tan ( θ ) \sqrt{{x}^{2} + {y}^{2}}$$

2. In one example, the function may be

$$f ( x , y , θ ) = θ \sqrt{{x}^{2} + {y}^{2}}$$

c. In one example, the base z coordinate may directly replace the z coordinate of the point.
d. In one example, the base z coordinate may replace the z coordinate of the point when some conditions are satisfied.
   i. In one example, one of the conditions may be that the difference between the z coordinate and the base z coordinate is less than a threshold.
      1. In one example, the threshold may be related to the geometry quantization step.
         a. In one example, the threshold may be set to the geometry quantization step.
e. In one example, the z coordinate of the point may be added by a function value of the difference between the z coordinate and the base z coordinate.
i. In one example, the function may be linear function, power function, exponential function, etc.
f. In one example, the revision may be performed at the encoder.
g. In one example, the revision may be performed at the decoder.
3) It is proposed to revise the x or y coordinates of one point according to the azimuthal angle of its capturing laser beam.
   a. In one example, each point is related to one capturing laser beam.
   b. In one example, a base x coordinate of the point will be obtained according to the azimuthal angle of its capturing laser beam.
      i. In one example, the base x coordinate x_{b} of the point (x, y, z) will be obtained as follows,

$${x}_{b} = f ( x , y , φ )$$

where φ is the azimuthal angle of the capturing laser beam, f ( ) is a function that can map the point to the azimuthal angle of the capturing laser beam in x direction.
c. In one example, the base x coordinate may directly replace the x coordinate of the point.
d. In one example, the base x coordinate may replace the x coordinate of the point when some conditions are satisfied.
   i. In one example, one of the conditions may be that the difference between x and the base x coordinate is less a threshold.
      1. In one example, the threshold may be related to the geometry quantization step.
         a. In one example, the threshold may be set to the geometry quantization step.
e. In one example, a base y coordinate of the point will be obtained according to the azimuthal angle of its capturing laser beam.
   i. In one example, the base y coordinate y_{b} of the point (x, y, z) will be obtained as follows,

$${y}_{b} = f ( x , y , φ )$$

where φ is the azimuthal angle of the capturing laser beam, f ( ) is a function that can map the point to the azimuthal angle of the capturing laser beam in y direction.
f. In one example, the base y coordinate may directly replace the y coordinate of the point.
g. In one example, the base y coordinate may replace the y coordinate of the point when some conditions are satisfied.
   i. In one example, one of the conditions may be that the difference between y and the base y coordinate is less a threshold.
      1. In one example, the threshold may be geometry quantization step.
         a. In one example, the threshold may be set to the geometry quantization step.
h. In one example, the revision may be performed at the encoder.
i. In one example, the revision may be performed at the decoder.
4) It is proposed to revise the coordinates of one point only if it satisfies some conditions.
   a. In one example, the coordinates may be x coordinate or/and y coordinate.
   b. In one example, the coordinates may be z coordinate.
   c. In one example, one of the conditions may be that the quantization distortion will not result in finding the wrong capturing laser.
      i. In one example, for the point (x, y, z), one of the conditions may be:

$$Q s < abs ( tan ( θ ) \sqrt{{x}^{2} + {y}^{2}} - tan ( {θ}_{n} ) \sqrt{{x}^{2} + {y}^{2}} )$$

where Qs is the geometry quantization step, θ is the elevation angle of the capturing laser, θₙ is the elevation angle of the previous laser or next laser, abs ( ) is the absolute function.
ii. In one example, for the point (x, y, z), one of the conditions may be:

$$Q s < abs ( θ \sqrt{{x}^{2} + {y}^{2}} - {θ}_{n} \sqrt{{x}^{2} + {y}^{2}} )$$

where Qs is the geometry quantization step, the θ is the elevation angle of the capturing laser, θₙ is the elevation angle of the previous laser or next laser, abs( ) is the absolute function.
d. In one example, one of the conditions may be that the quantization distortion will not result in finding the wrong capturing laser beam.
   i. In one example, the capturing laser beam may be found after having found the capturing laser.
e. The above conditions may be used independently or in combination to constrain the revision of coordinates.
5) It is proposed to use at least one indicator (e.g., being binary value) to indicate whether the prior information from LIDAR is used to revise the coordinates.
a. In one example, the prior information may be elevation angle information of lasers.
b. In one example, the prior information may be azimuthal angle of laser beams.
c. In one example, the coordinates may be x coordinate or/and y coordinate.
d. In one example, the coordinates may be z coordinate.
e. In one example, the coordinates may be of the decoded point clouds.
f. In one example, the indicator may be consistent in one coding unit.
   i. In one example, the coding unit may be frame.
   ii. In one example, the coding unit may be tile.
   iii. In one example, the coding unit may be slice.
   iv. In one example, the coding unit may be group of frames (GOF).
   v. In one example, the coding unit may be point cloud sequence.
g. In one example, the indicator may be signaled in the bitstream.
   i. Alternatively, the indicator may be inferred in decoder and/or encoder side.
h. In one example, the indicator may be signaled conditionally.
   i. In one example, the indicator may be signaled only if proposed coordinates revision is allowed.
      1. In one example, Whether the proposed coordinates revision is allowed may depend on coding information.
      2. In one example, Whether the proposed coordinates revision is allowed may be signaled.
i. In one example, the indicator may be binarized with fixed-length coding, EG coding, (truncated) unary coding, etc.
j. In one example, the indicator may be coded with at least one context in arithmetic coding.
k. In one example, the indicator may be bypass coded.
6) It is proposed to perform the geometry coordinates revision before the attribute coding.
   a. In one example, the attribute may be color, reflectance, normal, etc.
   b. In one example, the attribute coding may rely on the revised geometry coordinates.
7) It is proposed to perform the geometry coordinates revision after the attribute coding.
   a. In one example, the attribute may be color, reflectance, normal, etc.
   b. In one example, the attribute coding may not rely on the revised geometry coordinates.
8) Whether to and/or how to apply a method disclosed above may be signaled from encoder to decoder in a bitstream/frame/tile/slice/octree/etc.
9) Whether to and/or how to apply the disclosed methods above may be dependent on coded information, such as dimensions, colour format, colour component, slice/picture type.

### 6. Embodiments

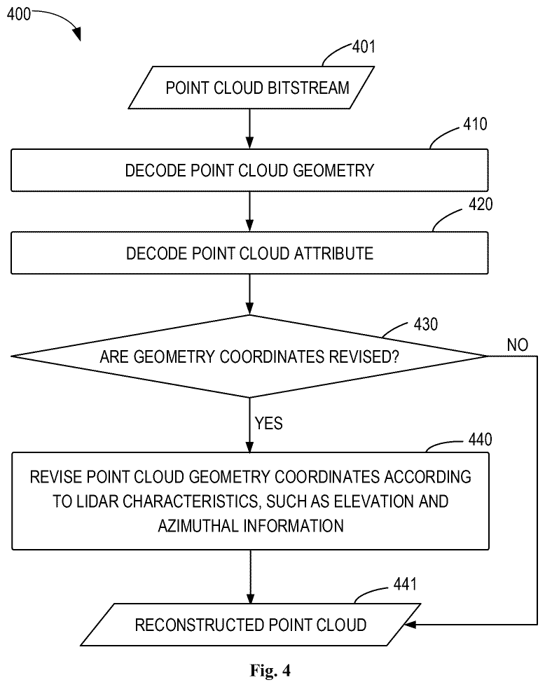

An example flowchart of the coding flow 400 for point cloud geometry coordinates revision using LIDAR characteristics is depicted in FIG. 4. As illustrated, at block 410, point cloud geometry of a point cloud bitstream 401 is decoded. For example, the point cloud geometry may include geometry coordinates of points in the point cloud sequence. At block 420, point cloud attribute of the point cloud bitstream 401 is decoded. At block 430, whether geometry coordinates are revised is determined. If the geometry coordinates are revised, at block 440, point cloud geometry coordinates are revised according to LIDAR characteristics, such as elevation and azimuthal information. Then, reconstructed point cloud 441 may be outputted. Otherwise, if the geometry coordinates are not revised, reconstructed point cloud 441 may be outputted.

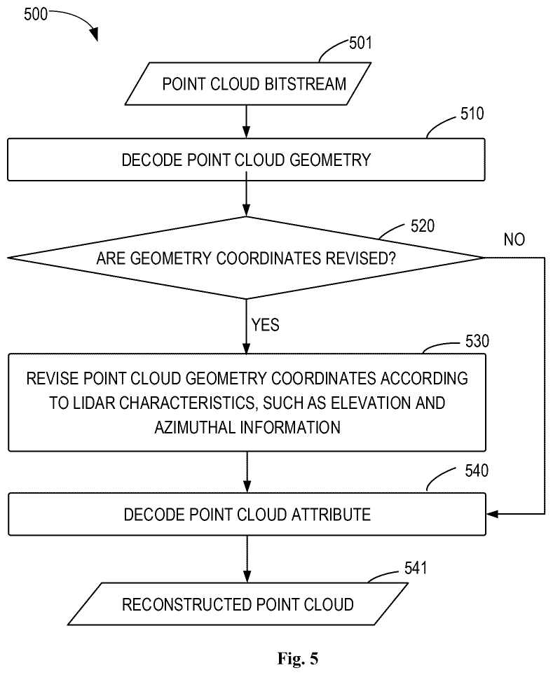

In another example, the point cloud attribute coding depends on the revised geometry coordinates. Another example flowchart of the coding flow 500 for point cloud geometry coordinates revision using LIDAR characteristics is depicted in FIG. 5. As illustrated, at block 510, point cloud geometry of a point cloud bitstream 501 is decoded. For example, the point cloud geometry may include geometry coordinates of points in the point cloud sequence. At block 520, whether geometry coordinates are revised is determined. If the geometry coordinates are revised, at block 530, point cloud geometry coordinates are revised according to LIDAR characteristics, such as elevation and azimuthal information. At block 540, point cloud attribute of the point cloud bitstream 501 is decoded. Then, reconstructed point cloud 441 may be outputted. Otherwise, if the geometry coordinates are not revised, at block 540, point cloud attribute of the point cloud bitstream 501 is decoded. Then, reconstructed point cloud 541 may be outputted.

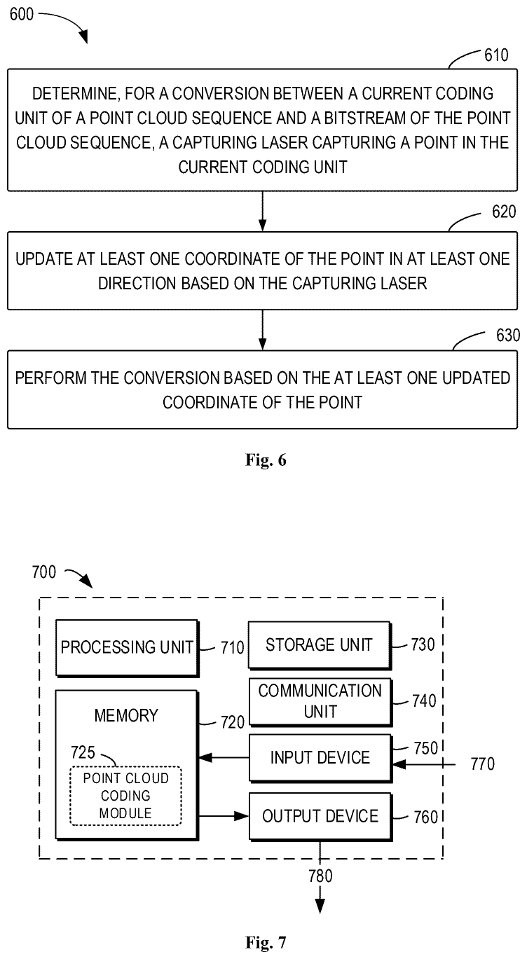

More details will be further discussed below. FIG. 6 illustrates a flowchart of a method 600 for point cloud coding in accordance with embodiments of the present disclosure. The method 600 is implemented for a conversion between a current coding unit of a point cloud sequence and a bitstream of the point cloud sequence.

At block 610, a capturing laser capturing a point in the current coding unit is determined. At block 620, at least one coordinate of the point in at least one direction is updated based on the capturing laser. As used herein, updating the coordinate may be referred to as “revising the coordinate” or “revision of the coordinate”. In some embodiments, the at least one coordinate of the point may comprises at least one of: a first coordinate of the point in a first direction such as coordinate x, a second coordinate of the point in a second direction such as coordinate y, or a third coordinate of the point in a third direction such as coordinate z. The location of the point may be represented by (x, y, z).

At block 630, the conversion is performed based on the at least one updated coordinate of the point. In some embodiments, the conversion includes encoding the current coding unit into the bitstream. Alternatively, or in addition, in some embodiments, the conversion includes decoding the current coding unit from the bitstream.

The method 600 enables revising the coordinate of the point based on the capturing laser. In this way, distortion of the geometry coordinate can be reduced. Thus, the effectiveness and efficiency of point cloud geometry coding can be improved.

In some embodiments, the capturing laser captures at least one point in collected point cloud data, the at least one point comprising the point.

In some embodiments, the at least one coordinate of the point is quantized.

In some embodiments, determining the capturing laser comprises: determining a plurality of differences between a plurality of metric values of a plurality of lasers and a metric value of the point; and determining the capturing laser based on the plurality of differences.

In some embodiments, a metric value of the point or a laser of the plurality of lasers comprises at least one of: an elevation angle of the point or the laser, a value positively related to the elevation angle of the point or the laser, a tangent value of the elevation angle of the point or the laser, a coordinate of the point or the laser, or a value associated with a coordinate of the point or the laser.

In some embodiments, the elevation angle of the point is determined based on the at least one coordinate of the point.

In some embodiments, the elevation angle of the point is determined by:

$$θ = arctan ( \frac{z}{\sqrt{{x}^{2} + {y}^{2}}} ) ,$$

where x denotes a first coordinate of the point in a first direction, y denotes a second coordinate of the point in a second direction, z denotes a third coordinate of the point in a third direction, θ denotes the elevation angle of the point, and arctan( ) denotes an arc-tangent metric.

In some embodiments, the tangent value of the elevation angle of the point is determined by:

$${θ}_{T} = \frac{z}{\sqrt{{x}^{2} + {y}^{2}}} ,$$

where x denotes a first coordinate of the point in a first direction, y denotes a second coordinate of the point in a second direction, z denotes a third coordinate of the point in a third direction, and Or denotes the tangent value of the elevation angle of the point.

In some embodiments, the elevation angle of the point or the laser is replaced by the tangent value of the elevation angle of the point or the laser.

In some embodiments, the capturing laser is a laser with a minimum difference among the plurality of differences.

In some embodiments, the capturing laser is determined based on a further capturing laser of a further coding unit coded before the current coding unit. That is, the capturing laser may be determined by inheriting from previous point.

In some embodiments, the capturing laser is determined by at least one of: an encoder or a decoder for the conversion.

In some embodiments, updating at least one coordinate of the point comprises: determining a revised third coordinate of the point based on a third coordinate of the point in a third direction and an elevation angle of the capturing laser of the point; and updating the third coordinate based on the revised third coordinate. As used herein, the revised third coordinate may be referred to as “base z”.

In some embodiments, the revised third coordinate of the point is determined based on a first metric mapping the point to the elevation angle of the capturing laser in the third direction. For example, the base z coordinate z_{b} of the point (x, y, z) will be obtained as follows,

$${z}_{b} = f ( x , y , θ )$$

where θ is the elevation angle of the capturing laser, f ( ) is a function that can map the point to the elevation angle of its capturing laser in z direction.

In some embodiments, the revised third coordinate of the point is determined further based on a laser head position shift in the third direction. For example, the revised third coordinate may be determined by adding the laser head position shift to a value determined by the first metric.

In some embodiments, the first metric comprises one of: f(x, y, θ)=tan(θ)\sqrt{x²+y²}, or f(x, y, θ)=θ\sqrt{x²+y²}, where x denotes a first coordinate of the point in a first direction, y denotes a second coordinate of the point in a second direction, and θ denotes the elevation angle of the point.

In some embodiments, updating the third coordinate based on the revised third coordinate comprises: replacing the third coordinate of the point by the revised third coordinate.

In some embodiments, the third coordinate of the point is replaced by the revised third coordinate based on at least one condition being satisfied.

In some embodiments, the at least one condition comprises a condition that a difference between the third coordinate of the point and the revised third coordinate is less than a threshold.

In some embodiments, the threshold is related to a step of geometry quantization.

In some embodiments, the threshold is a step of geometry quantization.

In some embodiments, updating the third coordinate based on the revised third coordinate comprises: determining a metric value of a difference between the third coordinate of the point and the revised third coordinate based on a second metric; and updating the third coordinate based on the metric value.

In some embodiments, the second metric comprises at least one of: a linear metric, a power metric, or an exponential metric.

In some embodiments, the third coordinate is updated by adding the metric value to the third coordinate.

In some embodiments, the third coordinate is updated by at least one of: an encoder or a decoder for the conversion.

In some embodiments, updating at least one coordinate of the point comprises: determining an azimuthal angle of a capturing laser beam of the capturing laser, the capturing laser beam being related to the point; and updating at least one of a first coordinate of the point in a first direction or a second coordinate of the point in a second direction based on the azimuthal angle of the capturing laser beam.

In some embodiments, updating the first coordinate of the point comprises: determining a revised first coordinate of the point based on the azimuthal angle; and updating the first coordinate based on the revised first coordinate. As used herein, the term “revised first coordinate” may be referred to “base x”.

In some embodiments, the revised first coordinate is determined based on a third metric mapping the point to the azimuthal angle of the capturing laser beam in the first direction.

In some embodiments, updating the first coordinate based on the revised first coordinate comprises: replacing the first coordinate of the point by the revised first coordinate.

In some embodiments, the first coordinate of the point is replaced by the revised first coordinate based on at least one condition being satisfied.

In some embodiments, the at least one condition comprises a condition that a difference between the first coordinate of the point and the revised first coordinate is less than a threshold.

In some embodiments, the threshold is related to a step of geometry quantization.

In some embodiments, the threshold is a step of geometry quantization.

In some embodiments, updating the second coordinate of the point comprises: determining a revised second coordinate of the point based on the azimuthal angle; and updating the second coordinate based on the revised second coordinate. As used herein, the term “revised second coordinate” may be referred to “base y”.

In some embodiments, the revised second coordinate is determined based on a fourth metric mapping the point to the azimuthal angle of the capturing laser beam in the second direction.

In some embodiments, updating the second coordinate based on the revised second coordinate comprises: replacing the second coordinate of the point by the revised second coordinate.

In some embodiments, the second coordinate of the point is replaced by the revised second coordinate based on at least one condition being satisfied.

In some embodiments, the at least one condition comprises a condition that a difference between the second coordinate of the point and the revised second coordinate is less than a threshold.

In some embodiments, the threshold is related to a step of geometry quantization.

In some embodiments, the threshold is a step of geometry quantization.

In some embodiments, at least one of the first or second coordinate is updated by at least one of: an encoder or a decoder for the conversion.

In some embodiments, the at least one coordinate of the point is updated based on at least one condition being satisfied.

In some embodiments, the at least one coordinate comprises at least one of: a first coordinate in a first direction, a second coordinate in a second direction, or a third coordinate in a third direction.

In some embodiments, the at least one condition comprises a condition that a quantization distortion of the point is less than or equal to a first threshold associated with the determining of the capturing laser. With such condition, the quantization distortion will not result in finding the wrong capturing laser.

In some embodiments, the at least one condition comprises:

$$Q s < abs ( tan ( θ ) \sqrt{{x}^{2} + {y}^{2}} - tan ( {θ}_{n} ) \sqrt{{x}^{2} + {y}^{2}} ) ,$$

where x denotes a first coordinate of the point in a first direction, y denotes a second coordinate of the point in a second direction, Qs denotes a step of geometry quantization, θ denotes an elevation angle of the capturing laser, θₙ denotes a further elevation angle of a further laser previous or next to the capturing laser, and abs( ) denotes the absolute function.

In some embodiments, the at least one condition comprises:

$$Q s < abs ( θ \sqrt{{x}^{2} + {y}^{2}} - {θ}_{n} \sqrt{{x}^{2} + {y}^{2}} ) ,$$

where x denotes a first coordinate of the point in a first direction, y denotes a second coordinate of the point in a second direction, Qs denotes a step of geometry quantization, θ denotes an elevation angle of the capturing laser, θₙ denotes a further elevation angle of a further laser previous or next to the capturing laser, and abs( ) denotes the absolute function.

In some embodiments, the at least one condition comprises a condition that a quantization distortion of the point is less than or equal to a second threshold associated with a determining of a capturing laser beam of the capturing laser. For example, the condition may be that the quantization distortion will not result in finding the wrong capturing laser beam.

It is to be understood that these conditions and any other suitable condition may be applied separately, or in any combination. Scope of the present disclosure is not limited here.

In some embodiments, the capturing laser beam is determined after determining the capturing laser. That is, the capturing laser beam may be found after having found the capturing laser.

In some embodiments, the at least one coordinate of the point is updated based on prior information of a laser system comprising at least one laser comprising the capturing laser of the point.

In some embodiments, coordinates of points in a coded point cloud are updated based on the prior information of the laser system, the at least one laser of the laser system capturing the points in the coded point.

In some embodiments, the prior information comprises at least one of: elevation angle information of the at least one laser, or azimuthal angle information of at least one laser beam of the at least one laser.

In some embodiments, the at least one coordinate comprises at least one of: a first coordinate in a first direction, a second coordinate in a second direction, or a third coordinate in a third direction.

In some embodiments, at least one indicator indicates whether to update the at least one coordinate based on the prior information or whether to update the coordinates of points in the coded point cloud based on the prior information.

In some embodiments, the at least one indicator is consistent in a coding unit. By way of example, the coding unit comprises one of: a frame, a tile, a slice, a group of frames (GOF), or the point cloud sequence.

In some embodiments, the at least one indicator is determined by at least one of: an encoder or a decoder for the conversion.

In some embodiments, the at least one indicator is included in the bitstream.

In some embodiments, the at least one indicator is included in the bitstream based on at least one condition being satisfied. In some embodiments, the at least one condition comprises that updating of the at least one coordinate is allowed.

In some embodiments, whether the updating of the at least one coordinate is allowed is based on coding information.

In some embodiments, whether the updating of the at least one coordinate is allowed is indicated in the bitstream.

In some embodiments, the at least one indicator is binarized with at least one of: a fixed-length coding, an exponential Golomb (EG) coding, a unary coding, or a truncated unary coding.

In some embodiments, the at least one indicator is coded with at least one context in arithmetic coding.

In some embodiments, the at least one indicator is bypass coded.

In some embodiments, updating the at least one coordinate is performed before attribute coding of the current coding unit.

In some embodiments, attribute information of the attribute coding comprises at least one of: color information, reflectance information, or normal information.

In some embodiments, the attribute coding is based on the at least one updated coordinate.

In some embodiments, updating the at least one coordinate is performed after attribute coding of the current coding unit.

In some embodiments, attribute information of the attribute coding comprises at least one of: color information, reflectance information, or normal information.

In some embodiments, the attribute information is coded without using the at least one updated coordinate.

In some embodiments, information regarding whether to and/or how to apply the method is included in at least one of: a frame, a tile, a slice, or an octree in the bitstream, or the bitstream.

In some embodiments, the information is based on coded information. By way of example, the coded information comprises at least one of: a dimension, a color format, a color component, a slice type, or a picture type.

According to further embodiments of the present disclosure, a non-transitory computer-readable recording medium is provided. The non-transitory computer-readable recording medium stores a bitstream of a point cloud sequence which is generated by a method performed by an apparatus for point cloud coding. In the method, a capturing laser capturing a point in a current coding unit of the point cloud sequence is determined. At least one coordinate of the point in at least one direction is updated based on the capturing laser. The bitstream is generated based on the at least one updated coordinate of the point.

According to still further embodiments of the present disclosure, a method for storing bitstream of a point cloud sequence is provided. In the method, a capturing laser capturing a point in a current coding unit of the point cloud sequence is determined. At least one coordinate of the point in at least one direction is updated based on the capturing laser. The bitstream is generated based on the at least one updated coordinate of the point. The bitstream is stored in a non-transitory computer-readable recording medium.

Implementations of the present disclosure can be described in view of the following clauses, the features of which can be combined in any reasonable manner.
Clause 1. A method for point cloud coding, comprising: determining, for a conversion between a current coding unit of a point cloud sequence and a bitstream of the point cloud sequence, a capturing laser capturing a point in the current coding unit; updating at least one coordinate of the point in at least one direction based on the capturing laser; and performing the conversion based on the at least one updated coordinate of the point.
Clause 2. The method of clause 1, wherein the capturing laser captures at least one point in collected point cloud data, the at least one point comprising the point.
Clause 3. The method clause 1 or 2, wherein the at least one coordinate of the point is quantized.
Clause 4. The method of any of clauses 1-3, wherein determining the capturing laser comprises: determining a plurality of differences between a plurality of metric values of a plurality of lasers and a metric value of the point; and determining the capturing laser based on the plurality of differences.
Clause 5. The method of clause 4, wherein a metric value of the point or a laser of the plurality of lasers comprises at least one of: an elevation angle of the point or the laser, a value positively related to the elevation angle of the point or the laser, a tangent value of the elevation angle of the point or the laser, a coordinate of the point or the laser, or a value associated with a coordinate of the point or the laser.
Clause 6. The method of clause 5, wherein the elevation angle of the point is determined based on the at least one coordinate of the point.
Clause 7. The method of clause 6, wherein the elevation angle of the point is determined by: θ=arctan

$$( \frac{z}{\sqrt{{x}^{2} + {y}^{2}}} ) ,$$

where x denotes a first coordinate of the point in a first direction, y denotes a second coordinate of the point in a second direction, z denotes a third coordinate of the point in a third direction, θ denotes the elevation angle of the point, and arctan ( ) denotes an arc-tangent metric.
Clause 8. The method of clause 5, wherein the tangent value of the elevation angle of the point is determined by:

$${θ}_{T} = \frac{z}{\sqrt{{x}^{2} + {y}^{2}}} ,$$

where x denotes a first coordinate of the point in a first direction, y denotes a second coordinate of the point in a second direction, z denotes a third coordinate of the point in a third direction, and θ_{T} denotes the tangent value of the elevation angle of the point.
Clause 9. The method of any of clauses 5-8, wherein the elevation angle of the point or the laser is replaced by the tangent value of the elevation angle of the point or the laser.
Clause 10. The method of any of clauses 4-9, wherein the capturing laser is a laser with a minimum difference among the plurality of differences.
Clause 11. The method of any of clauses 1-3, wherein the capturing laser is determined based on a further capturing laser of a further coding unit coded before the current coding unit.
Clause 12. The method of any of clauses 1-11, wherein the capturing laser is determined by at least one of: an encoder or a decoder for the conversion.
Clause 13. The method of any of clauses 1-12, wherein updating at least one coordinate of the point comprises: determining a revised third coordinate of the point based on a third coordinate of the point in a third direction and an elevation angle of the capturing laser of the point; and updating the third coordinate based on the revised third coordinate.
Clause 14. The method of clause 13, wherein the revised third coordinate of the point is determined based on a first metric mapping the point to the elevation angle of the capturing laser in the third direction.
Clause 15. The method of clause 14, wherein the revised third coordinate of the point is determined further based on a laser head position shift in the third direction.
Clause 16. The method of clause 15, wherein the revised third coordinate is determined by adding the laser head position shift to a value determined by the first metric.
Clause 17. The method of any of clauses 14-16, wherein the first metric comprises one of: f(x,y,θ)=tan(θ)\sqrt{x²+y²}, or f(x, y, θ)=θ\sqrt{x²+y²}, where x denotes a first coordinate of the point in a first direction, y denotes a second coordinate of the point in a second direction, and θ denotes the elevation angle of the point.
Clause 18. The method of any of clauses 13-17, wherein updating the third coordinate based on the revised third coordinate comprises: replacing the third coordinate of the point by the revised third coordinate.
Clause 19. The method of clause 18, wherein the third coordinate of the point is replaced by the revised third coordinate based on at least one condition being satisfied.
Clause 20. The method of clause 19, wherein the at least one condition comprises a condition that a difference between the third coordinate of the point and the revised third coordinate is less than a threshold.
Clause 21. The method of clause 20, wherein the threshold is related to a step of geometry quantization.
Clause 22. The method of clause 20, wherein the threshold is a step of geometry quantization.
Clause 23. The method of any of clauses 13-17, wherein updating the third coordinate based on the revised third coordinate comprises: determining a metric value of a difference between the third coordinate of the point and the revised third coordinate based on a second metric; and updating the third coordinate based on the metric value.
Clause 24. The method of clause 23, wherein the second metric comprises at least one of: a linear metric, a power metric, or an exponential metric.
Clause 25. The method of clause 23 or 24, wherein the third coordinate is updated by adding the metric value to the third coordinate.
Clause 26. The method of any of clauses 13-25, wherein the third coordinate is updated by at least one of: an encoder or a decoder for the conversion.
Clause 27. The method of any of clauses 1-26, wherein updating at least one coordinate of the point comprises: determining an azimuthal angle of a capturing laser beam of the capturing laser, the capturing laser beam being related to the point; and updating at least one of a first coordinate of the point in a first direction or a second coordinate of the point in a second direction based on the azimuthal angle of the capturing laser beam.
Clause 28. The method of clause 27, wherein updating the first coordinate of the point comprises: determining a revised first coordinate of the point based on the azimuthal angle; and updating the first coordinate based on the revised first coordinate.
Clause 29. The method of clause 28, wherein the revised first coordinate is determined based on a third metric mapping the point to the azimuthal angle of the capturing laser beam in the first direction.
Clause 30. The method of clause 28 or 29, wherein updating the first coordinate based on the revised first coordinate comprises: replacing the first coordinate of the point by the revised first coordinate.
Clause 31. The method of clause 30, wherein the first coordinate of the point is replaced by the revised first coordinate based on at least one condition being satisfied.
Clause 32. The method of clause 31, wherein the at least one condition comprises a condition that a difference between the first coordinate of the point and the revised first coordinate is less than a threshold.
Clause 33. The method of clause 32, wherein the threshold is related to a step of geometry quantization.
Clause 34. The method of clause 32, wherein the threshold is a step of geometry quantization.
Clause 35. The method of clause 27, wherein updating the second coordinate of the point comprises: determining a revised second coordinate of the point based on the azimuthal angle; and updating the second coordinate based on the revised second coordinate.
Clause 36. The method of clause 35, wherein the revised second coordinate is determined based on a fourth metric mapping the point to the azimuthal angle of the capturing laser beam in the second direction.
Clause 37. The method of clause 35 or 36, wherein updating the second coordinate based on the revised second coordinate comprises: replacing the second coordinate of the point by the revised second coordinate.
Clause 38. The method of clause 37, wherein the second coordinate of the point is replaced by the revised second coordinate based on at least one condition being satisfied.
Clause 39. The method of clause 38, wherein the at least one condition comprises a condition that a difference between the second coordinate of the point and the revised second coordinate is less than a threshold.
Clause 40. The method of clause 39, wherein the threshold is related to a step of geometry quantization.
Clause 41. The method of clause 39, wherein the threshold is a step of geometry quantization.
Clause 42. The method of any of clauses 27-41, wherein at least one of the first or second coordinate is updated by at least one of: an encoder or a decoder for the conversion.
Clause 43. The method of any of clauses 1-42, wherein the at least one coordinate of the point is updated based on at least one condition being satisfied.
Clause 44. The method of clause 43, wherein the at least one coordinate comprises at least one of: a first coordinate in a first direction, a second coordinate in a second direction, or a third coordinate in a third direction.
Clause 45. The method of clause 43 or 44, wherein the at least one condition comprises a condition that a quantization distortion of the point is less than or equal to a first threshold associated with the determining of the capturing laser.
Clause 46. The method of clause 43 or 44, wherein the at least one condition comprises: Qs<abs(tan(θ)\sqrt{x²+y²}−tan(θₙ)\sqrt{x²+y²}), where x denotes a first coordinate of the point in a first direction, y denotes a second coordinate of the point in a second direction, Qs denotes a step of geometry quantization, θ denotes an elevation angle of the capturing laser, θₙ denotes a further elevation angle of a further laser previous or next to the capturing laser, and abs( ) denotes the absolute function.
Clause 47. The method of clause 43 or 44, wherein the at least one condition comprises: Qs<abs(θ\sqrt{x²+y²}−θₙ\sqrt{x²+y²}), where x denotes a first coordinate of the point in a first direction, y denotes a second coordinate of the point in a second direction, Qs denotes a step of geometry quantization, θ denotes an elevation angle of the capturing laser, θₙ denotes a further elevation angle of a further laser previous or next to the capturing laser, and abs( ) denotes the absolute function.
Clause 48. The method of clause 43 or 44, wherein the at least one condition comprises a condition that a quantization distortion of the point is less than or equal to a second threshold associated with a determining of a capturing laser beam of the capturing laser.
Clause 49. The method of clause 48, wherein the capturing laser beam is determined after determining the capturing laser.
Clause 50. The method of any of clauses 1-49, wherein the at least one coordinate of the point is updated based on prior information of a laser system comprising at least one laser comprising the capturing laser of the point.
Clause 51. The method of clause 50, wherein coordinates of points in a coded point cloud are updated based on the prior information of the laser system, the at least one laser of the laser system capturing the points in the coded point.
Clause 52. The method of clause 50 or 51, wherein the prior information comprises at least one of: elevation angle information of the at least one laser, or azimuthal angle information of at least one laser beam of the at least one laser.
Clause 53. The method of any of clauses 50-52, wherein the at least one coordinate comprises at least one of: a first coordinate in a first direction, a second coordinate in a second direction, or a third coordinate in a third direction.
Clause 54. The method of clause 51, wherein at least one indicator indicates whether to update the at least one coordinate based on the prior information or whether to update the coordinates of points in the coded point cloud based on the prior information.
Clause 55. The method of clause 54, wherein the at least one indicator is consistent in a coding unit.
Clause 56. The method of clause 55, wherein the coding unit comprises one of: a frame, a tile, a slice, a group of frames (GOF), or the point cloud sequence.
Clause 57. The method of any of clauses 54-56, wherein the at least one indicator is determined by at least one of: an encoder or a decoder for the conversion.
Clause 58. The method of any of clauses 54-56, wherein the at least one indicator is included in the bitstream.
Clause 59. The method of clause 58, wherein the at least one indicator is included in the bitstream based on at least one condition being satisfied.
Clause 60. The method of clause 59, wherein the at least one condition comprises that updating of the at least one coordinate is allowed.
Clause 61. The method of clause 60, wherein whether the updating of the at least one coordinate is allowed is based on coding information.
Clause 62. The method of clause 60, wherein whether the updating of the at least one coordinate is allowed is indicated in the bitstream.
Clause 63. The method of any of clauses 54-62, wherein the at least one indicator is binarized with at least one of: a fixed-length coding, an exponential Golomb (EG) coding, a unary coding, or a truncated unary coding.
Clause 64. The method of any of clauses 54-62, wherein the at least one indicator is coded with at least one context in arithmetic coding.
Clause 65. The method of any of clauses 54-62, wherein the at least one indicator is bypass coded.
Clause 66. The method of any of clauses 1-65, wherein updating the at least one coordinate is performed before attribute coding of the current coding unit.
Clause 67. The method of clause 66, wherein attribute information of the attribute coding comprises at least one of: color information, reflectance information, or normal information.
Clause 68. The method of clause 66 or 67, wherein the attribute coding is based on the at least one updated coordinate.
Clause 69. The method of any of clauses 1-65, wherein updating the at least one coordinate is performed after attribute coding of the current coding unit.
Clause 70. The method of clause 69, wherein attribute information of the attribute coding comprises at least one of: color information, reflectance information, or normal information.
Clause 71. The method of clause 70, wherein the attribute information is coded without using the at least one updated coordinate.
Clause 72. The method of any of clauses 1-71, wherein information regarding whether to and/or how to apply the method is included in at least one of: a frame, a tile, a slice, or an octree in the bitstream, or the bitstream.
Clause 73. The method of clause 72, wherein the information is based on coded information.
Clause 74. The method of clause 73, wherein the coded information comprises at least one of: a dimension, a color format, a color component, a slice type, or a picture type.
Clause 75. The method of any of clauses 1-74, wherein the conversion includes encoding the current coding unit into the bitstream.
Clause 76. The method of any of clauses 1-74, wherein the conversion includes decoding the current coding unit from the bitstream.
Clause 77. An apparatus for point cloud coding comprising a processor and a non-transitory memory with instructions thereon, wherein the instructions upon execution by the processor, cause the processor to perform a method in accordance with any of clauses 1-76.
Clause 78. A non-transitory computer-readable storage medium storing instructions that cause a processor to perform a method in accordance with any of clauses 1-76.
Clause 79. A non-transitory computer-readable recording medium storing a bitstream of a point cloud sequence which is generated by a method performed by a point cloud processing apparatus, wherein the method comprises: determining a capturing laser capturing a point in a current coding unit of the point cloud sequence; updating at least one coordinate of the point in at least one direction based on the capturing laser; and generating the bitstream based on the at least one updated coordinate of the point.
Clause 80. A method for storing a bitstream of a point cloud sequence, comprising: determining a capturing laser capturing a point in a current coding unit of the point cloud sequence; updating at least one coordinate of the point in at least one direction based on the capturing laser; generating the bitstream based on the at least one updated coordinate of the point; and storing the bitstream in a non-transitory computer-readable recording medium.

### Example Device

FIG. 7 illustrates a block diagram of a computing device 700 in which various embodiments of the present disclosure can be implemented. The computing device 700 may be implemented as or included in the source device 110 (or the GPCC encoder 116 or 200) or the destination device 120 (or the GPCC decoder 126 or 300).

It would be appreciated that the computing device 700 shown in FIG. 7 is merely for purpose of illustration, without suggesting any limitation to the functions and scopes of the embodiments of the present disclosure in any manner.

As shown in FIG. 7, the computing device 700 includes a general-purpose computing device 700. The computing device 700 may at least comprise one or more processors or processing units 710, a memory 720, a storage unit 730, one or more communication units 740, one or more input devices 750, and one or more output devices 760.

In some embodiments, the computing device 700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 700 can support any type of interface to a user (such as “wearable” circuitry and the like).

The processing unit 710 may be a physical or virtual processor and can implement various processes based on programs stored in the memory 720. In a multi-processor system, multiple processing units execute computer executable instructions in parallel so as to improve the parallel processing capability of the computing device 700. The processing unit 710 may also be referred to as a central processing unit (CPU), a microprocessor, a controller or a microcontroller.

The computing device 700 typically includes various computer storage medium. Such medium can be any medium accessible by the computing device 700, including, but not limited to, volatile and non-volatile medium, or detachable and non-detachable medium. The memory 720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 730 may be any detachable or non-detachable medium and may include a machine-readable medium such as a memory, flash memory drive, magnetic disk or another other media, which can be used for storing information and/or data and can be accessed in the computing device 700.

The computing device 700 may further include additional detachable/non-detachable, volatile/non-volatile memory medium. Although not shown in FIG. 7, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 740 communicates with a further computing device via the communication medium. In addition, the functions of the components in the computing device 700 can be implemented by a single computing cluster or multiple computing machines that can communicate via communication connections. Therefore, the computing device 700 can operate in a networked environment using a logical connection with one or more other servers, networked personal computers (PCs) or further general network nodes.

The input device 750 may be one or more of a variety of input devices, such as a mouse, keyboard, tracking ball, voice-input device, and the like. The output device 760 may be one or more of a variety of output devices, such as a display, loudspeaker, printer, and the like. By means of the communication unit 740, the computing device 700 can further communicate with one or more external devices (not shown) such as the storage devices and display device, with one or more devices enabling the user to interact with the computing device 700, or any devices (such as a network card, a modem and the like) enabling the computing device 700 to communicate with one or more other computing devices, if required. Such communication can be performed via input/output (I/O) interfaces (not shown).

In some embodiments, instead of being integrated in a single device, some or all components of the computing device 700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 700 may be used to implement point cloud encoding/decoding in embodiments of the present disclosure. The memory 720 may include one or more point cloud coding modules 725 having one or more program instructions. These modules are accessible and executable by the processing unit 710 to perform the functionalities of the various embodiments described herein.

In the example embodiments of performing point cloud encoding, the input device 750 may receive point cloud data as an input 770 to be encoded. The point cloud data may be processed, for example, by the point cloud coding module 725, to generate an encoded bitstream. The encoded bitstream may be provided via the output device 760 as an output 780.

In the example embodiments of performing point cloud decoding, the input device 750 may receive an encoded bitstream as the input 770. The encoded bitstream may be processed, for example, by the point cloud coding module 725, to generate decoded point cloud data. The decoded point cloud data may be provided via the output device 760 as the output 780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1. A method for point cloud coding, comprising:
determining, for a conversion between a current coding unit of a point cloud sequence and a bitstream of the point cloud sequence, a capturing laser capturing a point in the current coding unit;
updating at least one coordinate of the point in at least one direction based on the capturing laser; and
performing the conversion based on the at least one updated coordinate of the point.

2. The method of claim 1, wherein the capturing laser captures at least one point in collected point cloud data, the at least one point comprising the point, wherein the at least one coordinate of the point is quantized, and/or
wherein determining the capturing laser comprises:
determining a plurality of differences between a plurality of metric values of a plurality of lasers and a metric value of the point; and
determining the capturing laser based on the plurality of differences, or
wherein the capturing laser is determined based on a further capturing laser of a further coding unit coded before the current coding unit.

3. The method of claim 2, wherein a metric value of the point or a laser of the plurality of lasers comprises at least one of: an elevation angle of the point or the laser, a value positively related to the elevation angle of the point or the laser, a tangent value of the elevation angle of the point or the laser, a coordinate of the point or the laser, or a value associated with a coordinate of the point or the laser,
wherein the elevation angle of the point is determined based on the at least one coordinate of the point, wherein the elevation angle of the point is determined by:
$$θ = arctan ( \frac{z}{\sqrt{{x}^{2} + {y}^{2}}} ) ,$$
where x denotes a first coordinate of the point in a first direction, y denotes a second coordinate of the point in a second direction, z denotes a third coordinate of the point in a third direction, θ denotes the elevation angle of the point, and arctan( ) denotes an arc-tangent metric, and/or
wherein the tangent value of the elevation angle of the point is determined by:
$${θ}_{T} = \frac{z}{\sqrt{{x}^{2} + {y}^{2}}} ,$$
where x denotes a first coordinate of the point in a first direction, y denotes a second coordinate of the point in a second direction, z denotes a third coordinate of the point in a third direction, and Or denotes the tangent value of the elevation angle of the point, or
wherein the elevation angle of the point or the laser is replaced by the tangent value of the elevation angle of the point or the laser, or
wherein the capturing laser is a laser with a minimum difference among the plurality of differences.

4. The method of claim 1, wherein the capturing laser is determined by at least one of: an encoder or a decoder for the conversion.

5. The method of claim 1, wherein updating at least one coordinate of the point comprises:
determining a revised third coordinate of the point based on a third coordinate of the point in a third direction and an elevation angle of the capturing laser of the point; and
updating the third coordinate based on the revised third coordinate,
wherein the revised third coordinate of the point is determined based on a first metric mapping the point to the elevation angle of the capturing laser in the third direction,
wherein the revised third coordinate of the point is determined further based on a laser head position shift in the third direction, or
wherein the revised third coordinate is determined by adding the laser head position shift to a value determined by the first metric,
wherein the first metric comprises one of:
$$f ( x , y , θ ) = tan ( θ ) \sqrt{{x}^{2} + {y}^{2}} , or$$
$$f ( x , y , θ ) = θ \sqrt{{x}^{2} + {y}^{2}} ,$$
where x denotes a first coordinate of the point in a first direction, y denotes a second coordinate of the point in a second direction, and θ denotes the elevation angle of the point.

6. The method of claim 5, wherein updating the third coordinate based on the revised third coordinate comprises:
replacing the third coordinate of the point by the revised third coordinate,
wherein the third coordinate of the point is replaced by the revised third coordinate based on at least one condition being satisfied,
wherein the at least one condition comprises a condition that a difference between the third coordinate of the point and the revised third coordinate is less than a threshold,
wherein the threshold is related to a step of geometry quantization, or
wherein the threshold is a step of geometry quantization.

7. The method of claim 5, wherein updating the third coordinate based on the revised third coordinate comprises:
determining a metric value of a difference between the third coordinate of the point and the revised third coordinate based on a second metric; and
updating the third coordinate based on the metric value,
wherein the second metric comprises at least one of: a linear metric, a power metric, or an exponential metric, and/or
wherein the third coordinate is updated by adding the metric value to the third coordinate.

8. The method of claim 5, wherein the third coordinate is updated by at least one of: an encoder or a decoder for the conversion.

9. The method of claim 1, wherein the at least one coordinate of the point is updated based on at least one condition being satisfied,
wherein the at least one coordinate comprises at least one of: a first coordinate in a first direction, a second coordinate in a second direction, or a third coordinate in a third direction.

10. The method of claim 9, wherein the at least one condition comprises a condition that a quantization distortion of the point is less than or equal to a first threshold associated with the determining of the capturing laser, or
wherein the at least one condition comprises:
$$Q s < abs ( tan ( θ ) \sqrt{{x}^{2} + {y}^{2}} - tan ( {θ}_{n} ) \sqrt{{x}^{2} + {y}^{2}} ) ,$$
where x denotes a first coordinate of the point in a first direction, y denotes a second coordinate of the point in a second direction, Qs denotes a step of geometry quantization, θ denotes an elevation angle of the capturing laser, θₙ denotes a further elevation angle of a further laser previous or next to the capturing laser, and abs( ) denotes the absolute function, or
wherein the at least one condition comprises:
$$Q s < abs ( θ \sqrt{{x}^{2} + {y}^{2}} - {θ}_{n} \sqrt{{x}^{2} + {y}^{2}} ) ,$$
where x denotes a first coordinate of the point in a first direction, y denotes a second coordinate of the point in a second direction, Qs denotes a step of geometry quantization, θ denotes an elevation angle of the capturing laser, θₙ denotes a further elevation angle of a further laser previous or next to the capturing laser, and abs( ) denotes the absolute function, or
wherein the at least one condition comprises a condition that a quantization distortion of the point is less than or equal to a second threshold associated with a determining of a capturing laser beam of the capturing laser, wherein the capturing laser beam is determined after determining the capturing laser.

11. The method of claim 1, wherein the at least one coordinate of the point is updated based on prior information of a laser system comprising at least one laser comprising the capturing laser of the point,
wherein coordinates of points in a coded point cloud are updated based on the prior information of the laser system, the at least one laser of the laser system capturing the points in the coded point,
wherein the prior information comprises at least one of: elevation angle information of the at least one laser, or azimuthal angle information of at least one laser beam of the at least one laser, and/or
wherein the at least one coordinate comprises at least one of: a first coordinate in a first direction, a second coordinate in a second direction, or a third coordinate in a third direction.

12. The method of claim 11, wherein at least one indicator indicates whether to update the at least one coordinate based on the prior information or whether to update the coordinates of points in the coded point cloud based on the prior information,
wherein the at least one indicator is consistent in a coding unit, wherein the coding unit comprises one of: a frame, a tile, a slice, a group of frames (GOF), or the point cloud sequence.

13. The method of claim 12, wherein the at least one indicator is determined by at least one of: an encoder or a decoder for the conversion.

14. The method of claim 12, wherein the at least one indicator is included in the bitstream,
wherein the at least one indicator is included in the bitstream based on at least one condition being satisfied,
wherein the at least one condition comprises that updating of the at least one coordinate is allowed,
wherein whether the updating of the at least one coordinate is allowed is based on coding information, or
wherein whether the updating of the at least one coordinate is allowed is indicated in the bitstream.

15. The method of claim 12, wherein the at least one indicator is binarized with at least one of: a fixed-length coding, an exponential Golomb (EG) coding, a unary coding, or a truncated unary coding, or
wherein the at least one indicator is coded with at least one context in arithmetic coding, or
wherein the at least one indicator is bypass coded.

16. The method of claim 1, wherein updating the at least one coordinate is performed after attribute coding of the current coding unit,
wherein attribute information of the attribute coding comprises at least one of: color information, reflectance information, or normal information, and/or
wherein the attribute information is coded without using the at least one updated coordinate.

17. The method of claim 1, wherein the conversion includes encoding the current coding unit into the bitstream, or
wherein the conversion includes decoding the current coding unit from the bitstream.

18. An apparatus for point cloud coding comprising a processor and a non-transitory memory with instructions thereon, wherein the instructions upon execution by the processor, cause the processor to:
determine, for a conversion between a current coding unit of a point cloud sequence and a bitstream of the point cloud sequence, a capturing laser capturing a point in the current coding unit;
update at least one coordinate of the point in at least one direction based on the capturing laser; and
perform the conversion based on the at least one updated coordinate of the point.

19. A non-transitory computer-readable storage medium storing instructions that cause a processor to perform a method comprising:
determining, for a conversion between a current coding unit of a point cloud sequence and a bitstream of the point cloud sequence, a capturing laser capturing a point in the current coding unit;
updating at least one coordinate of the point in at least one direction based on the capturing laser; and
performing the conversion based on the at least one updated coordinate of the point.

20. A non-transitory computer-readable recording medium storing a bitstream of a point cloud sequence which is generated by a method performed by a point cloud processing apparatus, wherein the method comprises:
determining a capturing laser capturing a point in a current coding unit of the point cloud sequence;
updating at least one coordinate of the point in at least one direction based on the capturing laser; and
generating the bitstream based on the at least one updated coordinate of the point.
